(19) United States
(12) Patent Application Publication
(10) Pub. No.: US 2003/0169521 A1
(43) Pub. Date: Sep. 11, 2003

(54) Rearview mirror and method of manufacturing same

(76) Inventor: Poul E. Hoegh, San Jose, CA (US)

Correspondence Address: Poul E. Hoegh, 854 N 16th St., San Jose, CA, 95112, US

(21) Appl. No.: 10/093,191

(22) Filed: Mar. 7, 2002

(51) Int. Cl. G02B 5/10

(52) U.S. Cl. 359/864; 359/868

(57) ABSTRACT

A rearview mirror for vehicles or the like, comprising in a unitary structure a substantially flat reflecting central surface that at each end of the flat central surface progresses gradually into a series of convex, spherical reflective surfaces having progressively smaller spherical radii progressing from the flat central surface, thereby eliminating deadspots in the drivers view toward the rear and the sides of of the vehicle. This invention provides exact and undistorted view to the rear of the vehicle, permitting accurate judgement of distances to articles and other vehicles behind the driver, and gradually reducing images to the sides of the vehicle in a panoramic view without distorting them, so the driver at all times has recogniseable views behind and to the sides of the vehicle. This particularly facilitates changing lanes and the like without incurring accidents. Included is a preferred method of manufacturing the reflecting surface to transgress from a flat surface to a series of spherical surfaces without any transfer line.

### COMMENTS ON PRIOR ART found in inventor's search.

AA. U.S. Pat. No 1.643,420 by E. Porter Sep. 27, 1927 shows a central flat mirror cylindrically bent at each end into convex and concave sections, that distort the views to the left and to the right very considerably so that it is hard to recognise articles on either side.

AB. U.S. Pat. No. 2,536,872 by C. F. Cookson Jan. 2, 1951 shows a series of flat angled mirrors that take up a large part of the windshield and do not show a continued view but broken up, confusing view.

AC. U.S. Pat. No. 2,605,676 by F. J. Couch Aug. 5, 1952 shows a flat mirror with a spherical mirror attached at each end, leaving dead spots at the attachment points at each end.

AD. U.S. Pat. No. 2,857,810 by J. A. Troendle Aug. 28, -. shows a flat mirror with cylindrical and conical end portions, that distort the side views considerably.

AE. U.S. Pat. No. 2,979,989 by W. L. Calder Jr. Apr. 18, 1961 shows a flat mirror with a pivotable flat mirror attached at each end, that provides considerable blind spots at each end.

AL. German patent No. W 13362 II/63c by Dr. Wilhelm Ropke shows a rearview mirror that has adjoined at least one auxilliary adjustable concave mirror mounted in one common holder.

None of the patents found in the search have disclosed a rearview mirror having an unbroken, undistorted panoramic view to the rear and to the sides of a vehicle as the view provided by the present invention.

### FIELD OF THE INVENTION

This invention relates to mirrors and more particularly to improvements in rearview mirrors for automobiles, vehicles, and the like.

### BACKGROUND OF THE INVENTION

The conventional type of rearview mirror for automobiles or the like, consisting of a flat piece of mirror located inside the windshield, at the top thereof, in front of the driver, has the disadvantage that it only allows the driver of the automobile or vehicle to see a comparatively small portion of the view to the rear of the vehicle, leaving blind spots that can not be viewed, providing inherant possibilities of causing accidents when changing lanes and the like.

In order to get a larger panoramic view to the rear of a vehicle, a larger or longer mirror can be utilized, this however having the disadvantage that a larger portion of the view straight ahead is impeded by the size of the rearview mirror, yet still leaving blind spots at either side behind the vehicle.

To obtain a larger view to the rear of a vehicle, curved mirrors have been utilized at the top of the windshield, but these have the disadvantage that vision directly behind the vehicle is distorted to such a degree, that judgement of distances, for instance to another vehicle approaching from the rear, is made very difficult, not to say impossible, as is judging the distance to other obstacles when backing up the car or vehicle.

Other mirrors have been devised, consisting of a flat piece of mirror for viewing directly to the rear of the vehicle, in combination with auxiliary small mirrors attached at each end of the central flat mirror, giving a part view out to each side of the rear of the vehicle, this having the disadvantage that a large blind spot is left between the field of view of the central mirror and the auxuliary mirrors, these latter being comparatively small in order not to take up too much of the drivers forward vision. Furthermore each attached mirror must be adjusted individually and accurately to get a better field of view, and can easily inadvertently be brought out of adjustment.

In order to supplement the field of vision seen in the internal rearview mirror, outside rearview mirrors have been utilized on one or both sides of the vehicle, these having the disadvantage that they are easily soiled and brought out of adjustment. These outside mirrors usually have to be viewed through side windows of the vehicle, which can be a marked disadvantage in rainy or bad weather, and even these outside mirrors do not give the driver a view in all the blind spots.

### SUMMARY OF THE INVENTION

The principal object of this invention is to provide a rearview mirror that gives a very wide angle of vision, so wide in fact that the viewer gets a field of view covering not only the rear of the vehicle, but also the normally blind spots at both sides of the viewer. When the invention, for instance, is used as a rearview mirror for a vehicle, the mirror can be made to enable the driver to see anything at the rear of the vehicle and along each side thereof to the point where the drivers field of vision is covered by the naked eye in front of the driver, thereby giving the driver a 100 per cent vision around the vehicle, of which, for instance, approximately 100 degrees may be covered by the drivers vision straight ahead, and approximately 260 degrees may be covered by the drivers field of view in the present invention, substantially without distortion so that articles seen in this rearview mirror may be filly recognized, no matter which part of this new rearview mirror is being viewed.

It is another object of this invention to provide a rearview mirror that allows an undistorted panoramic view toward the rear of the driver in order, for instance, to allow the driver to correctly judge distances behind the driver when backing up a vehicle.

It is another object of this invention to provide a rear view mirror that eliminates all normally blind spots behind and to the sides of the vehicle, which blind spots have been the cause of many bad accidents hitherto.

It is further an object of this invention to provide a rearview mirror that does not distort view to the side of a vehicle but allows people, buildings etc. to be clearly recognized, but just slightly reduced in size as seen in a spherical mirror.

### BRIEF DESCRIPTION OF THE DRAWINGS

FIG. 1. is a plan view of the driving compartment of a vehicle with the present invention in conventional place inside the front windshield, illustrating a drivers view to the rear and sides of the vehicle, utilizing a rearview mirror incorporating the present invention.

FIG. 2 is a perspective view of a rearview mirror incorportating the present invention, illustrating substantially how a circle of a constant size will be seen in different locations viewed along the length of the rearview mirror, when viewed by a driver utilizing the present invention.

FIG. 3 is a perspective view of a pattern used to form the reflecting mirror surface of a rearview mirror incorporating the present invention.

FIG. 4 is a frontal elevation of a preferred method of forming the surface of a pattern used to provide the needed profile on the face of a mirror to accommodate the features of the present invention, shown machining the central, fiat portion of the pattern being machined.

FIG. 5 is a frontal elevation of the method illustrated in FIG. 4. showing machining of the progressively spherically curved end portions of the pattern.

### DESCRIPTION OF THE PREFERRED EMBODIMENT

This invention is based on the novel concept that a flat surface can be construed as being a spherical surface having an infinitely large spherical radius, it being possible to gradually and progressively merge such a flat surface with infinitely large radii, as incorporated in the center portion of the present invention, progressively into a series of adjacent, substantially sperical surfaces with progressively smaller radii, by simply by reducing the infinitely large spherical radius of the center portion gradually into a series of surfaces with progressively smaller radii, simultaneously in longitudinal and transverse direction, progressing from the central flat portion of the rearview mirror surface toward each end of the rearview mirror surface, the profile of the surface progressing transversely and longitudinally at the same time gradually and progressively at substantially the same rate. Thus a rearview spherical mirror surface is formed that progresses from a flat central portion of the rearview mirror that may, for instance, constitute approximately one third of the surface length, while, for instance, approximately one third of the surface length at each end of the rearview mirror may curve gradually and progressively into a series of convex, substantially spherical curves with progressively smaller spherical radii travelling from the central flat portion of the surface toward each end of the surface.

### DESCRIPTION OF ONE PREFERRED METHOD OF PROVIDING A PATTERN OR MOLD WITH A SUITABLE SURFACE REQUIRED TO PRODUCE A REARVIEW MIRROR ACCORDING TO THE PRESENT INVENTION.

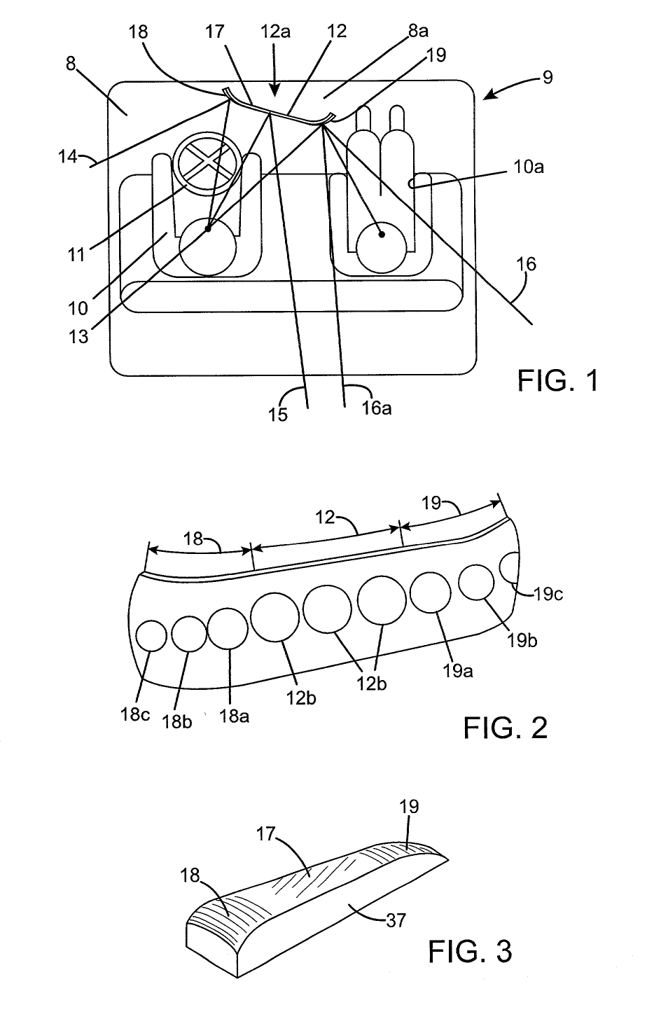

Referring to FIG. 1, a planview of the driving compartment of a conventional vehicle 8 such as automobile 9 is shown with a driver 10 in position at the steering wheel 11. A rearview mirror 12 according to the present invention is located inside windshield 8a in convential position at 12a suitable to cover view of both sides and rear of vehicle 8 from viewpoint 13 of driver 10

A number of angles of inflection are shown giving the field of view from viewpoint 13 to the left of vehicle 8 designated by view line 14, to the rear of vehicle 8 designated by view line 15 and to the right of vehicle 8 designated by view line 16.

The entire panoramic view around the back and sides of vehicle 8 is covered by rearview mirror 12 up to the direct frontal view of driver 10. The portion of rear view covered by a flat, central portion 17 of mirror 12 provides normal rear view without distortion of judgement of distance.

The portions of rearview and sideview covered by convexly curved, spherical end portions 18 and 19 will cover the normally blind spot portions of rearview and provide undistorted, progressively reduced, easily recogniseable images of traffic to either side of vehicle 8 in rearview mirror 12.

Driver 10 can therefore at a single glance at rearview mirror 12 ascertain and clearly recognise any traffic behind and around vehicle 8. A passenger 10a sitting next to driver 10 will also have a view toward the rear of vehicle 8 in rearview mirror 12 as shown by view line 16a thereby doubling the safety factor of the rear view mirror.

Referring to FIG. 2, images of true circles seen in a rearview mirror located in vehicle 9 of FIG. 1, incorporating the present invention are shown. Image 12b of a true circle located behind vehicle 9 is seen as a true circle, similar to that seen in a normal flat rearview mirror. Images 18a, 18b and 18c of true circles to the left of vehicle 9 are seen as progressively smaller, but still substantially true circles. Images 19a, 19b, and 19c of true circles to the right of vehicle 9 are seen as progressively smaller, but still substantially true circles. These images are all undistorted and therefore give the driver a true and immediately recogniseable view around the back and sides of vehicle 9 and eliminates all blind spots.

Referring to FIG. 3 a perspective view of a pattern 37 used to form the surfaces of the rear view mirror of the present invention is shown, encompassing flat central surface 17 and progressively reduced radii, spherical end surfaces 18 and 19 of the rearview mirror.

In order to provide a suitable profile on a mirror according to the present invention, a mold or pattern surface must be developed in a mold or pattern, in the following called a pattern, to provide the surface characteristics involved in the present invention, so that these characteristics may be transfered to actual mirrors during production thereof. The longitudinal and transversal shape of this profile must be controlled simultaneously, progressing from a central flat portion of the mirror toward substantially spherical surfaces at each ends of the mirror.

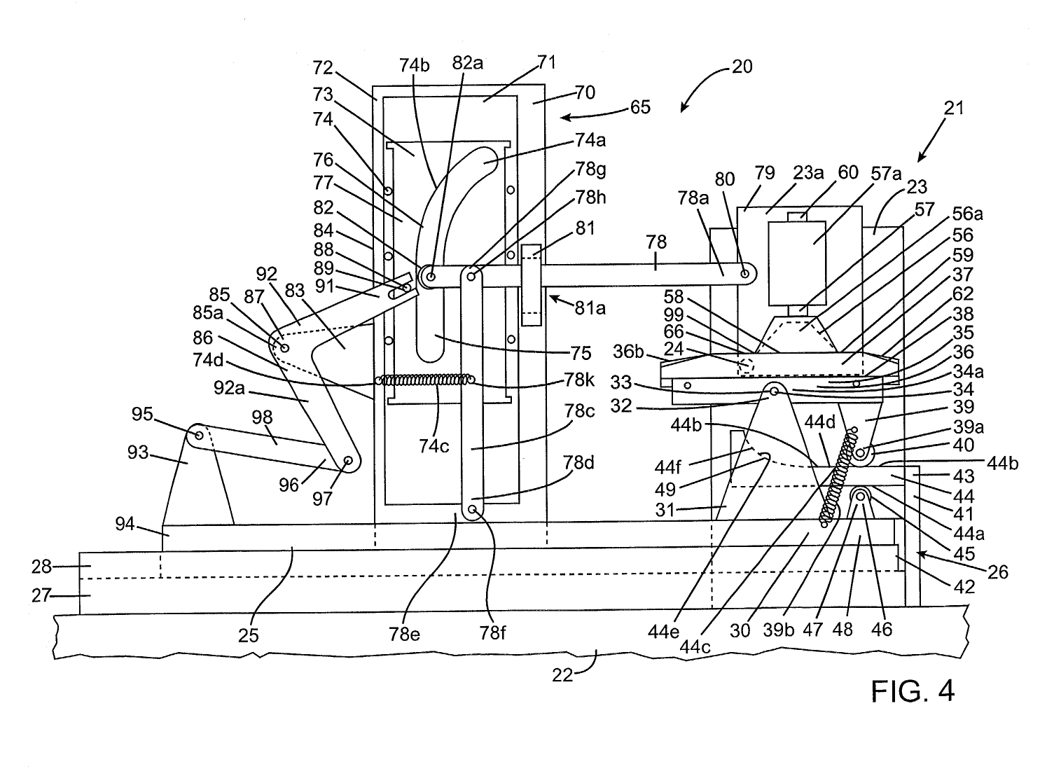

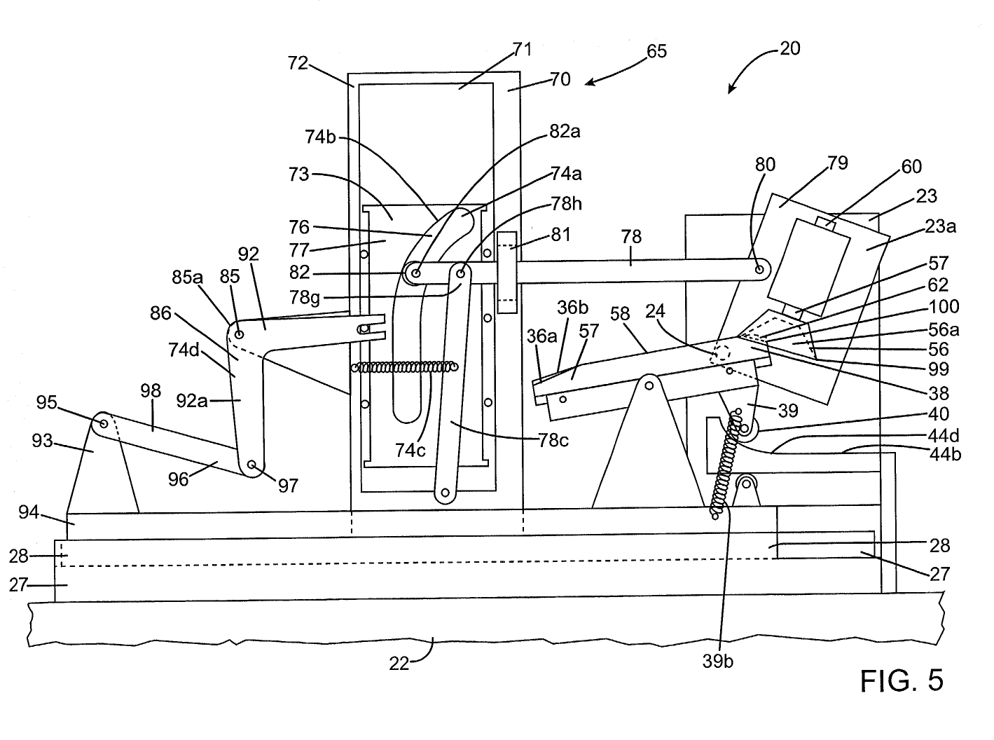

Referring to FIG. 4 and FIG. 5 a preferred method of accomplishing this is disclosed at 20 comprising the use of a machine, such as, for instance, a milling machine 21 to machine the required surface on a pattern, to accomplish the features of this invention. Milling machine 21 has a conventional, horizontally movable table 22 and a vertical stationary column 23 behind table 22.

A plate 23a is pivotably mounted vertically in front of column 23 at plate pivot axis 24. A horizontal, longitudinal slide shown at 26 consists of a lower slide portion 27 mounted firmly on table 22 and an upper slide portion 28 mounted longitudinably slideable in lower slide portion 27. A baseplate 25 is mounted on upper slide portion 28.

Plate 25 carries towards it's right end 30, a primary bearing block 31 which at it's upper end 32 carries a pivot bearing 33 to engage in a pivot pin 34, substantially in the center 34a of side 35 of pattern holder 36 into which a pattern 37 is inserted and held for the ensuing machining operation. The right hand end 38 of pattern holder 36 is supplied with a downward depending support roller block 39. Into lower end 39a of roller block 39 a downward depending support roller 40 is journalled.

In order to provide the transverse components of a spherical convex surface with progressively decreasing spherical radii transversely accross pattern surface 62, an upwardly extending end plate 41 is attached at right hand end 42 of lower slide 27. A primary camlever 44 is fastened to the left of upper end 43 of plate 41. Camlever 44 has a lower edge 44a that moves horizontally along and above lower support roller 45 that is rotatably mounted in upper end 46 of lower roller block 47, that extends upwards from right hand end 48 of base plate 25. Lower edge 44a of camlever 44 is straight and horizontal and is adapted to move along and above lower roller 45. Upper edge 44b of cam lever 44 has its right hand portion 44c formed straight and horizontal. Left hand portion 44d is advantageously formed to progress upward, for instance, as part of an elipse.

The cutting tool used to machine the flat and curved surfaces of the pattern may, for instance, be a cupshaped or flared cutter or grinding wheel 56, in the following called a cutter, on a rotating spindle 57 that is driven by a motor 57a and maintained perpendicular to flat central surface 58 during machining of flat central portion 58 of pattern 37, as pattern 37 is slowly moved to the left relative to rotating cutter 56 due to motion of upper slide portion 28 moving to the left during cutting operation. Cutter 56 will provide a flat surface on central portion 58 of pattern 37 until the end 59 of flat portion 58 of pattern 37 has been reached. As pattern 37 slowly continues to move to the left, the upper end 60 of spindle 57a, that is controlled by a secondary cam system shown at 70a and explained further below, will be progressively tilted toward the right hand end 38 of pattern 37, providing a progressively decreasing spherically radiused, convex surface 64, transversely accross and longitudinally along pattern surface 62.

The central flat surface 58, of pattern 37, that may be construed as a spherically cut surface having an infinitely large spherical radius on surface 58 of pattern 37, will now gradually become an increasingly more convex, spherically curved surface having increasingly smaller radii longitudinally and transversely toward each end of pattern 37, as pattern moves under cutter 56.

This is accomplished by letting roller 40 roll up on the concave curved elipse edge portion 44e of cam lever 44. Righthand end 61 of pattern 37 will start to tip upwards into central cavity 56a of flared cutter 56, as pattern holder 36 pivots counterclockwise on pivot bearing 33. As flared cutter 56 rotates on spindle 57 the resulting cut on pattern 37 will have the configuration of a convex curve transverse of pattern end surface 62, as upper slide portion 28 moves to the left along lower slide portion 27. As the horizontal edge 44c progresses tangentially into concave elipse portion 44d, righthand end 61 of pattern holder 36 will progressively tip more and more into cavity 56a of flared cutter 56, controlled by primary camlever 44, constantly reducing the radius of the profile of the cut transversely and longitudinally along surface 62.

A secondary cam mechanism shown at 65 controls the tilting motion of spindle 57 and motor 57a in conjunction with primary cam lever 44 to provide the desired progressive reduction in spherical curve radii, simultaneusly transversely and longitudinally along upper end surface 62 on pattern 37, as machining progresses lengthwise along surface 62 toward righthand end 38 of pattern 37, providing a substantially spherical convex surface on surface 62 with a constantly decreasing spherical radius progressing toward righthand end 38 of pattern.37.

Upper roller 40 is adapted to roll along upper edge 44b of camlever 44. As upper slide portion 28 moves to the left in lower slide portion 27, roller 40 will move to the left along horizontal righthand portion 44c of cam lever 44 as central flat portion 58 of pattern 37 is being machined by flared cutter 56, while spindle 57 is in vertical position. Left end portion 49 of upper edge 50 of camlever 44 has the concave configuration of a quarter of an ellipse 44e, that progresses tangentially from horizontal portion 50a of camlever 44 upwards and to the left as the curvature of ellipse 44e progressively increases.

As soon as roller 40 starts to roll up on curved elipse 44e of camlever 44, righthand end 38 of pattern 37 will start to tip upwards into center cavity 56a of flared cutter 56 as pattern holder 36 pivots on pivot bearing 33. Since the horizontal portion 44c of cam lever 44 passes tangentially into the concave elipse 44e of camlever 44, the transition will pass very smoothly and almost unnoticeably from flat surface 58 to spherically curved surfaces 36b and 62.

A rectangular,.vertical frame 70 is located on lower slide 27, behind upper slide 28. A rectangular cavity 71 is indented into front surface 72 of frame 70. A sliding block 73 is located vertically slideable in cavity 71. Steel balls 74 may be suitably inserted between frame 70 and block 73 to reduce friction as block 73 is moved up and down in frame 70. A slot 74a is indented into front surface 77 of block 73 and consists of a part vertical lower portion 75 that converges into an upper oval part 76 that curves toward upper righthand end 76a of block 73.

A connecting rod 78 has it's righthand end 78a pivotably attached toward left upper corner 79 of vertical plate 23a at 80. Connecting rod 78 passes through a retaining bracket 81, attached to righthand side of frame 70 at 81a. and slides accross the front of frame 70 to directly in front of slot 74a where a pivotal roller 82 on pivot pin 82a extends horizontally from rod 78 into slot 74a. A stabilizer lever 78c has it's lower end 78d pivotably attached on lower end 78e of frame 70 at 78f. Upper end 78g of stabilizer lever 78c is pivotably attached to connecting rod 78 at 78h.

A horizontal support arm 83 extends out from left side 84 of frame 70 and carries a pivot 85 at its left end 85a. A quadrant 86 has a central bearing 87 rotatably carried on pivot 85 on support arm 83, and has a first arm 92 extending toward frame 70, and has a second arm 92a depending downward from pivot 85. A horizontally outward extending pin 88 is located on surface 77 of sliding block 73 and fits slidingly into a slot 89 at righthand end 91 of arm 92. Left edge 74b of slot 74a is a governing edge. A tension spring 74c is located between stabilizing lever 78c at 78k and left side 84 of frame 72 at 74d, spring 74c maintaining intimate connection between roller 82 and governing edge 74b.

Baseplate 25 has a bearing block 93 extending upward from left end 94 of base plate 25 to an upper pivot 95 on bearing block 93. Extreme lower end 96 of second arm 92a has a pivot 97. A connecting lever 98 is located pivotally between pivot 95 and pivot 97.

Lower vertical slot portion 75 maintains spindle 57 in a vertical position while roller 82 passes up along lower vertical slotportion 75 as sliding block 73 is moved upwards in this portion of slot 75, by first quadrant arm 92, as sliding block 73 is moved upwards, whereby cutting edge 99 of flared cutter 56 will machine a flat, horizontal surface on central portion 58 of pattern 37. During machining operation of this flat pattern surface 58, upperslide 28 is moved horizontally in lower slide 27 to the left, untill roller 40 has reached the end of horizontal portion 44c, at start 44d of eliptical concave curve 44e. Cutter 56 has now travelled from start position 66 to righthand end position 59 of flat pattern surface 58. The lengths of levers and quadrant arms are chosen to move roller 82 suitably through vertical slot portion 75 during this portion of horizontal machining.

Referring particularly to FIG. 5, continuing to move upper slide 28 to the left in lower slide 27, roller 82 will slowly enter upper eliptic portion 76 of slot 75, slot 75 continuing to progress upward as a portion of a suitable elipse, with the radius of the concave curve of the eliptic portion gradually but constantly decreasing as roller 82 moves up the elipsed curved slot 76. As roller 82 moves up eliptical curved slot 76, connecting rod 78 will gradually be moved to the right, gradually tipping plate 23 clockwise to the right about pivot axis 24, tipping spindle 57 to the right, out of perpendicular relationship with flat surface 58 of pattern 37.

As upper slide 28 moves to the left along lower slide 27, roller 40 will move left along horizontal upper edge 44b of cam lever 44 during machining of horizontal flat surface 58 of pattern 37, roller 40 will reach 44d where horizontal upper edge 44b stops and where horizontal upper edge 44b tangentially merges into concave ellipse curve 44e. Concave ellipse curve 44e progresses upward and to the left. As upper slide 28 continues to move to the left in lower slide 27, roller 40 continues to move to the left up along concave ellipse curve 44e through a gradually and constantly eliptical decreasing curve radius. As roller 40 starts to move up along ellipse curve 44e, plate 23a is simultaneously gradually tipped clockwise about pivot bearing 24. by combined action of elipse curve 44e and eliptic slot 76, righthand end 38 of pattern 37 enters more and more into central cavity 56a of cutter 56. As upper slide 28 continues to move to the left, cutter 56 will gradually machine a convex curved surface with constantly decreasing radii longitudinally and transversally of pattern surface 62. Choosing suitable ellipses in slot 76 and on camlever 44 provides coresponding radii in longitudinal and transversal direction, to supply constantly decreasing radii in both directions resulting in decreasing,, substantially spherical surfaces along end surface 62 of pattern 37 down to the extreme righthand end 100 of pattern 37.

If desired, the reduction of spherical radius may be stopped before end 100 has been reached so that the final end portion is machined with no further reduction of spherical radius.

To machine the remaining lefthand portion 36a of pattern 37, pattern 37 may be taken out of pattern holder 33, reversed 180 degrees length wise and replaced in pattern holder 36. The same operation as described directly above is now repeated for lefthand portion 36a so that surface 36b on lefthand end, and surface 62 on righthand end of pattern 37 may become substantially identically machined.

Pattern 37 has now been supplied with the correct required surfaces 58, 62 and 36b, ready to transfer to a rearview mirror according to this invention in conventional manner. To make plastic mirrors, the pattern may be made of steel and suitably embedded in an injection mold for mass producing copies of the convex side of the pattern in clear sheet plastic. The plastic mirror will now have a convex side and a concave side. The concave side of the clear plastic is thereafter supplied with a mirror surface in conventional manner, and mounted in a mirror holder for viewing through from the convex side, and mounted inside a windshield in conventional manner for a fill and substantially undistorted panoramic view behind and to both sides of a vehicle.

Glass mirrors may be made by locating a piece of glass sheet on top of above pattern, the pattern being made of suitable material such as graphite to withstand heat, and placed in an oven to heat it sufficiently to allow the glass to assume the form of the pattern by gravity or other convential means.

As an example only, the rearview mirror may be made a total length of, for instance, 9 inches long, in which case the central flat piece may be made, for instance, 3 inches long, and each progressively curved, spherical end might, for instance, be made 3 inches long.

It will be understood that although specific embodiments of the invention have herein been described and illustrtated, it is recognized that departures may be made therefrom within the scope of the invention which is therefore not to be limited to the details disclosed herein, as the invention also contemplates variations in design as may hold within the scope of the appended claims.

Numbering List.

NUMBERING LIST.

| | |
|---|---|
| 8. | Driving compartment |
| 8a | Windshield |
| 9 | Automobile |
| 10 | Driver |
| 10a | Passenger |
| 11 | Steering wheel |
| 12 | Rearview mirror |
| 12a | Location of mirror |
| 12b | True image of circle |
| 13 | Viewpoint |
| 14 | View line to left |
| 15 | View line to rear |
| 16 | View line to right |
| 16a | Passenger view line |
| 17 | Flat center of mirror |
| 18 | Left Spherical end |
| 18a, 18b, 18c | Reduced, but undistorted left images of circles |
| 19 | Right spherical end |
| 19a, 19b, 19c | Reduced but undistorted right image of circles |
| 20 | Preferred method |
| 21 | Milling machine |
| 22 | Horizontal table |
| 23 | Vertical column |
| 23a | Vertical plate |
| 24 | Pivot axis of plate |
| 25 | Base plate |
| 26 | Slide |
| 27 | Lower portion |
| 28 | Upper portion |
| 30 | Upper portion right end of plate 25 |
| 31 | Primary bearing block |
| 32 | Primary bearing block upperend |
| 33 | Pivot bearing |
| 34 | pivot pin |
| 34a | Center of side 35 |
| 35 | Side of pattern holder |
| 36 | Pattern holder |
| 36b | Lefthand end convex surface of pattern |
| 37 | Pattern |
| 38 | Right end convex surface of pattern |
| 39 | Down projecting roller block |
| 39a | Lower end of block 39 |
| 39b | Extension spring between roller 40 and camlever 44 |
| 40 | Upper roller |
| 41 | Upward extending plate |
| 42 | Right end of lower slide portion |
| 43 | Upper end of plate 41 |
| 44 | Primary cam lever |
| 44a | Horizontal lower edge of 44 |
| 44b | Upper edge of 44 |
| 44c | Right hand horizontal portion of 44b |
| 44d | Start edge of left eliptical curve |
| 44e | Concave eliptical curve of cam |
| 44f | Left end of eliptical curve |
| 45 | Lower roller |
| 46 | Upper end of lower roller block |
| 47 | Lower roller block |
| 48 | Right hand end of upper slide 28 |
| 49 | Left part of upper cam edge |
| 56 | Flared cutter |
| 56a | Central cavity in flared cutter |
| 57 | Spindle |
| 57a | motor |
| 58 | Central flat surface portion of pattern |
| 59 | Right hand end of flat portion |
| 60 | Upper end of spindle |
| 61 | Right hand end of pattern holder |
| 62 | Upper right hand end convex surface of pattern |
| 65 | Cam mechanism |
| 66 | Start position of flat surface |
| 70 | Frame |
| 71 | Cavity in frame |
| 72 | Front surface of frame |
| 73 | Vertical sliding block |
| 74 | Steel balls |
| 74a | Slot in sliding block 73 |
| 74b | Governing edge of slot 74a |
| 74c | Tension spring |
| 74d | Spring between roller 82 and edge 74b |
| 75 | Vertical slot portion |
| 76 | Upper eliptical secondary cam slot portion |
| 77 | Front surface of sliding block 73 |
| 78 | Connecting rod |
| 78a | Right hand end of connecting rod |
| 78b | Left hand end of connecting rod |
| 78c | Stabilizer rod |
| 78d | Lower end of stabilizer rod |
| 78e | Lower end of frame |
| 78f | Lower attachment of stabilizer rod |
| 78g | Upper end of stabilizer rod |
| 78k | Spring attachment on 78c |
| 78h | Upper pivot attachment of stabilizer rod. |
| 79 | Upper end of plate 23a |
| 80 | Attachment location on plate 23a |
| 81 | Bearing block |
| 81a | Right hand side of frame |
| 82 | Secondary roller |
| 82a | roller pivot pin |
| 83 | Horizontally extending support arm |
| 84 | Left side of frame |
| 85 | Pivot in support arm 83 |
| 85a | Left end of support arm |
| 86 | Quadrant |
| 87 | Central bearing of quadrant |
| 91 | Righthand end of 92 |
| 94 | Left end of baseplate 25 |
| 95 | Upper pivot in block 93 |
| 96 | Lower end of second arm 92a |
| 97 | Lower pivot in 92a |
| 98 | Connecting lever 92a to 93 |
| 99 | Cutting edge of cutter |
| 100 | Righthand end of 62 |

1. A rearview mirror having a light reflecting surface comprising a central flat elongated portion, at least one end of said central flat portion converging into a substantially spherical convex mirror portion.

2. A rearview mirror having a light reflecting surface comprising a central elongated mirror portion, said central portion having a flat surface comprising a spherical surface with infinitely large spherical radius, at least one end of said central portion converging into a substantially spherical mirror portion with progressively reducing spherical radii.

3. A rearview mirror as claimed in claim 2, said flat central portion having two ends, at least one of said two ends converging tangentially into a convex curved, substantially spherical mirror portion, curvature of said convex spherical curve constantly increasing as said curve progresses toward each extreme end of said rearvew mirror, said reflecting surface being produced by a special preferred manufacturing method.

4. A rearview mirror as claimed in claim 3, in which each said spherical mirror portion comprises a convex spherical curved surface formed by a plurality of progressively shorter radii, as said curve progresses from said central flat portion toward each end of said rearview mirror, said mirror thereby obtaining a substantially convex surface and an opposite substantially concave surface, said light reflecting surface being located on said concave surface, mirror images being viewed on said convex surface through said transparent material.

5. A rearview mirror as claimed in claim 4, in which said reducing radii of said spherical convex curves progress only partway toward one or both said extreme ends of said rearview mirror, said radii thereafter remaining constant in length as they progress toward each said extreme end of said rearview mirror.

6. A rear view mirror as claimed in claim 4, in which at least one of said ends extends so far out from said central flat portion, that said rearview mirror can be used by more than one person at the same time.

7. A rearview mirror as claimed in claim 4, in which said special preferred manufacturing method comprises machine means having a slide adapted to move longitudinally under a cupshaped rotating cutter, axis of said cutter being selectively controlled by said slide to pivot from a position perpendicular to said slide to an inclined position to said slide, a mold pattern secured in a pivotable pattern holder, primary cam means on said slide to control pivoting of said pattern holder, secondary cam means to control said axis positions activated by said slide movement, said movement of said slide being adapted to simultaneously control said pivoting of said axis and pivoting of said pattern holder to accomplish machining of said flat portion and said substantially spherical curves of said surfaces of said end portions of said pattern, to leave no discernable border between said flat portion and said spherical mirror portions.
